(19) United States
(12) Patent Application Publication
(10) Pub. No.: US 2007/0102926 A1
(43) Pub. Date: May 10, 2007

(54) Flanged connection device

(75) Inventors: Isabelle Magnier, Notre Dame De L'Isle (FR); Christian Roure, Vernon (FR)

Correspondence Address: OBLON, SPIVAK, MCCLELLAND, MAIER & NEUSTADT, P.C., 1940 DUKE STREET, ALEXANDRIA, VA, 22314, US

(73) Assignee: SNECMA, Paris (FR)

(21) Appl. No.: 11/542,378

(22) Filed: Oct. 4, 2006

(30) Foreign Application Priority Data
Oct. 5, 2005 (FR) 0510169

(51) Int. Cl. F16L 23/00

(52) U.S. Cl. 285/368; 285/412

(57) ABSTRACT

The flanged prestressed leaktight connection device comprises a gasket housing formed between first and second contact surfaces of flanges for receiving a sealing gasket, associated with clamping elements disposed between the gasket housing and the periphery of the flanges. The first and second contact surfaces present at least a first bearing zone situated between the sealing gasket and the clamping elements, and a second bearing zone situated between the clamping elements and the periphery of the flanges, such that after the clamping elements have been tightened, the minimum force exerted on the second bearing zone is less than the minimum force exerted on the first bearing zone, but without being zero.

### FIELD OF THE INVENTION

The present invention relates to a flanged prestressed leaktight connection device comprising a first flange presenting a first contact surface, a second flange presenting a second contact surface situated facing said first contact surface, a sealing gasket disposed in a gasket housing formed between said first and second contact surfaces, and clamping means for clamping together the first and second flanges, the clamping means being disposed between the gasket housing and the periphery of the first and second flanges so as to put into contact at least a portion of the first and second contact surfaces between the flanges.

The invention relates more particularly to leaktight connection devices for use in severe environments with extreme operating conditions, in particular under high pressure, in the presence of vibration, and over temperature ranges that are very high or on the contrary very low.

### PRIOR ART

To assemble members that are subjected to high internal pressure, such as, for example engines or pipework used in space, it is common practice to use flanged leaktight connections providing a face-to-face connection, as shown for example in FIGS. 1 to 3.

FIG. 1 shows an example of a connection between two pipework elements 10 and 20 fitted with flanges 30 and 40 of the face-to-face type that are assembled together using connection members 50 such as bolts.

FIG. 2 is an axial section showing the FIG. 1 connection in an initial state before pressure is exerted inside the pipework elements 10 and 20. At this instant, after the bolts 50 have been tightened, the plane face 31 of the cylindrical plane flange 30 is pressed against the plane face 41 of the cylindrical plane flange 40 that is situated facing the flange 30. The flange 40 presents a step 42 that defines an empty space 70 for receiving a sealing gasket 60, which is thus held captive between the face 31 of the flange 30 and the step 42 of the flange 40.

As can be seen in FIG. 3, in operation with internal pressure P created by the presence of fluid inside the pipework elements 10 and 20, the faces 31′ and 41′, 42′ of the flanges 30 and 40 deform under the action of the pressure field inside the connection. This opens the housing 70 for the gasket 60. As a result, the sealing gasket 60 expands and loses a portion of its performance.

In an attempt to conserve leaktightness, it is necessary to use special gaskets having a large amount of usable elastic restitution, which are more complicated to manufacture, e.g. than gaskets such as those described in patent documents EP-A-0 261 350, EP-A-0 711 938, or EP-A-0 851 258. Such special gaskets designed specifically to handle the problem of the housing 70 opening, thus present non-negligible production costs.

In addition, repeated opening and closing of the housing 70 in the event of operation with repeated “ON/OFF” cycles, as applies for example to rocket engines, generates wear and fatigue in the gaskets. The relative flexibility of a face-to-face type connection makes it difficult to control the lifetime of systems. Reducing excess flexibility in such a face-to-face connection requires the weight of the flange to be increased, and that is penalizing, in particular for space applications.

Proposals have also been made, as in the embodiment shown in FIGS. 4 and 5, to form a land 33 on a face 31 of a first flange 30 facing a face 41 of a second flange 40, in a zone that is situated between the gasket housing 70 containing a sealing gasket 60, and the connection means 50 applying prestress on the annular flanges 30, 40 associated with the pipework elements 10, 20 or with other elements defining an enclosure of axis 1.

Under such circumstances, prior to tightening the connection means 50 and applying internal pressure, an empty space E (FIG. 4) is defined at the periphery of the flanges 30, 40 between the surface 31a of the flange 30 outside the land 33 and the surface 41 of the flange 40.

In operation, after the connection means have been tightened, and in the presence of a pressure field P inside the pipework 10, 20, the empty space between the surface 31a′ of the flange 30 and the surface 41′ of the flange 40 becomes smaller and enables the land 33 of the flange 30 to remain in contact with the surface 41′ of the flange 40. Nevertheless, at the periphery of the flanges 30, 40, the empty space between the surfaces 31a′ and 41′ does not close completely. This leads to various drawbacks because there is a risk of pollution entering the empty space between the flanges, and this empty space leads to creep over time, thereby producing bending in the plates of the flanges which are not held in reliable manner by the connection elements 50 because of the clearance that exists.

### OBJECT AND BRIEF SUMMARY OF THE INVENTION

The invention seeks to remedy the above-mentioned drawbacks and to provide a flanged prestressed leaktight connection device that does not make it essential to use special gaskets having a very high level of elastic restitution and that minimizes the risks of pollution or of the connection becoming modified during operation under severe conditions of temperature, pressure, vibration, and chemical attack, while being suitable for implementation without extra cost and without increasing the weight of the connection device.

These objects are achieved by a flanged prestressed leaktight connection device comprising a first flange presenting a first contact surface, a second flange presenting a second contact surface situated facing said first contact surface, a sealing gasket disposed in a gasket housing formed between said first and second contact surfaces, and clamping means for clamping together the first and second flanges, the clamping means being disposed between the gasket housing and the periphery of the first and second flanges so as to put into contact at least a portion of the first and second contact surfaces between the flanges, wherein the first and second contact surfaces present at least a first bearing zone situated in the vicinity of the sealing gasket and a second bearing zone situated between the clamping means and the periphery of the first and second flanges, such that after the clamping means have been tightened, the minimum force exerted on the second bearing zone is less than the minimum force exerted on the first bearing zone, but without being zero; wherein the sealing gasket presents usable restitution that is less than 0.1 millimeters (mm); and wherein the first and second contact surfaces define first and second bearing zones such that after the clamping means have been tightened, the minimum force exerted on the second bearing zone constitutes 1% to 20%, preferably 5% to 20%, and more preferably 8% to 12% of the minimum force exerted on the first bearing zone.

The device of the invention thus makes it possible to control the deformation of the flanges which, in prior art devices, leads to the gasket being off-loaded.

By minimizing the deformation of the flanges at the gasket housing, it is possible to achieve the sealing function while avoiding having recourse to special gaskets with a high level of usable restitution, which gaskets present high performance and are expensive.

Because, during assembly of the flanges, a bending stress field is generated in opposition to the field that is generated when the connection is put under pressure, the deformation of the flanges when put under pressure is minimized, in particular at the location of the gasket housing.

Furthermore, the presence of two bearing zones makes it possible to avoid the risks of pollution and of the connection deteriorating while in use, while contributing to controlling the stiffness of the flanged connection and to reducing fatigue in the connection means, thereby increasing reliability, without involving additional constraints relating to the weight of the connection device, nor implying extra machining costs.

In an aspect of the invention, prior to the clamping means being tightened, the distance between the first and second contact surfaces in the second bearing zone is greater than the distance between the first and second contact surfaces in the first bearing zone.

In a first possible embodiment, the first and second contact surfaces are continuous surfaces between the first and second bearing zones.

This embodiment is preferred, in particular when it is desired to encourage the removal of heat through the flanged connection.

In another possible embodiment, at least one of the first and second contact surfaces defines a land at least in one of the first and second bearing zones.

This embodiment provides a high level of control over the forces exerted on the flanges and the connection means.

More particularly, a connection device in this embodiment may be such that the first contact surface of the first flange has a first land formed in the first bearing zone and a second land formed in the second bearing zone, while the second contact surface of the second flange presents a continuous uniform surface.

In another possible embodiment, the first contact surface of the first flange includes a first land formed in the first bearing zone, while the second contact surface of the second flange presents a second land formed in the second bearing zone.

The first bearing zone is advantageously situated between the sealing gasket and the clamping means, thus making it possible in particular to protect the gasket thoroughly against the outside environment.

The connection device of the invention is particularly adapted for including a sealing gasket presenting usable restitution (Ru) lying in the range 2 mm to 0.1 mm.

The connection device of the invention can be applied to pipework or to an enclosure containing a fluid under pressure, in particular for use in space or indeed in industrial sectors such as the chemical, petrochemical, or nuclear industries that involve using equipments under pressure under environmental conditions that can be severe.

### BRIEF DESCRIPTION OF THE DRAWINGS

Other characteristics and advantages of the invention appear from the following description of particular embodiments given with reference to the accompanying drawings, in which:

FIG. 1 is a perspective view of an example of a prior art flanged connection;

FIGS. 2 and 3 are axial section views of an example of a prior art flanged connection device of the face-to-face type, respectively prior to tightening and after tightening the bolts that provide prestress;

FIGS. 4 and 5 are axial half-section views of an example of a prior art flanged connection device of the type having a single land, shown respectively before tightening and after tightening the bolts that provide prestress;

FIGS. 6 and 7 are axial half-section views of a first example of a flanged prestressed leaktight connection device of the invention of the type having continuous surfaces, respectively before and after tightening the bolts that provide prestress;

FIGS. 8 and 9 are axial half-section views of a second example of a flanged prestress leaktight connection device of the invention of a type having two lands formed on a single flange, and shown respectively before and after tightening the bolts that provide prestress;

FIG. 10 is a simplified graph showing variation in the compression force on a gasket as a function of the flattening thereof;

FIGS. 11 and 12 are axial half-section views of a third example of a flanged prestressed leaktight connection device of the invention, of the type having two lands formed on two different flanges, and shown respectively before and after tightening the bolts that provide prestress;

FIG. 13 is an axial half-section view showing the application of a leaktight connection device of the invention to a tank of fluid under pressure;

FIGS. 14 and 15 are detail views showing the leaktight connection device for the tank of FIG. 13, and shown respectively before and after tightening the pins that provide prestress;

FIG. 16 is a graph showing the variation in the tension in a pin of the device of FIGS. 14 and 15 while it is being put under pressure, as a function of the conicity of the surfaces of the flanges of the leaktight connection device; and

FIG. 17 is a graph showing the off-loading and the usable restitution of a gasket as a function of the conicity of the surfaces of the flanges of the leaktight connection device of FIGS. 14 and 15.

### DETAILED DESCRIPTION OF PARTICULAR EMBODIMENTS

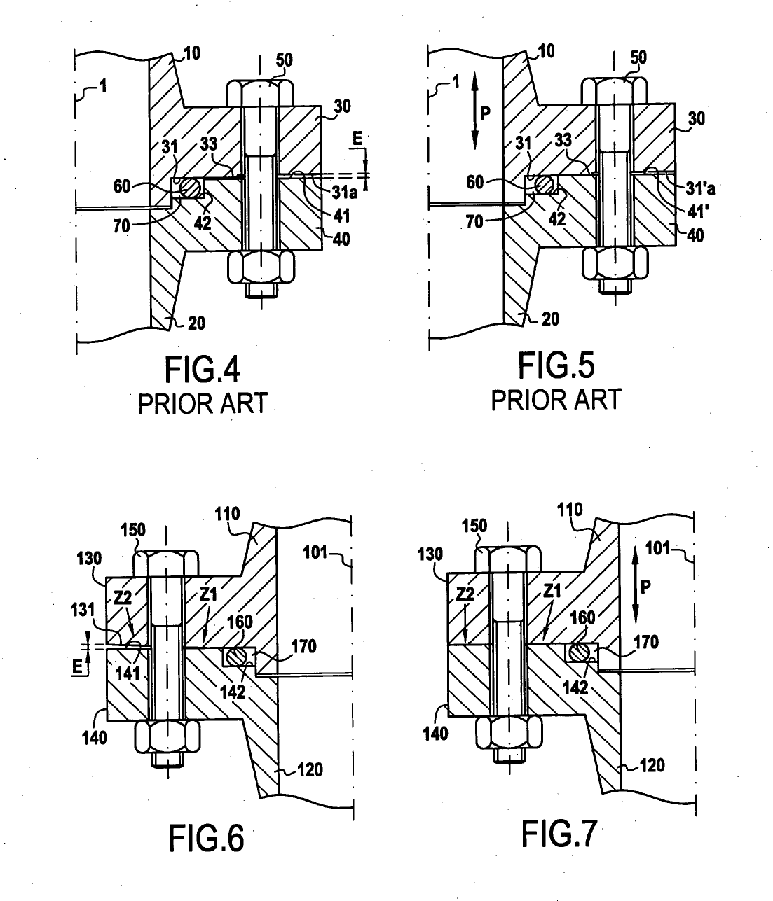

Reference is made initially to FIG. 10 which shows in simplified manner how the compression force on a gasket varies as a function of the flattening of the gasket in a conventional flanged connection device of the kinds described with reference to FIGS. 1 to 5.

Curve C in its portion between points O and A represents compression of the gasket during a stage in which the gasket is being flattened, as occurs when the flanges are assembled together and the connection elements are tightened.

Curve D is an off-loading straight line, and between points A and B it represents variation in the off-loading of the connection, referenced d, i.e. the relaxing of the gasket from its maximum flattening δ obtained during assembly, and as occurs under the effect of operating pressure being applied inside the pipework elements or the tank elements interconnected by the flanged connection, the force exerted on the gasket passing from a value F_{A} at point A to a lower value F_{B} at point B.

In order for the connection to be leaktight, the value F_{B} must remain greater than a sealing limit force written Fₛₑₐₗ, which corresponds to the usable restitution Ru of the gasket.

The connection remains leaktight if the usable restitution Ru of the gasket remains greater than the off-loading d.

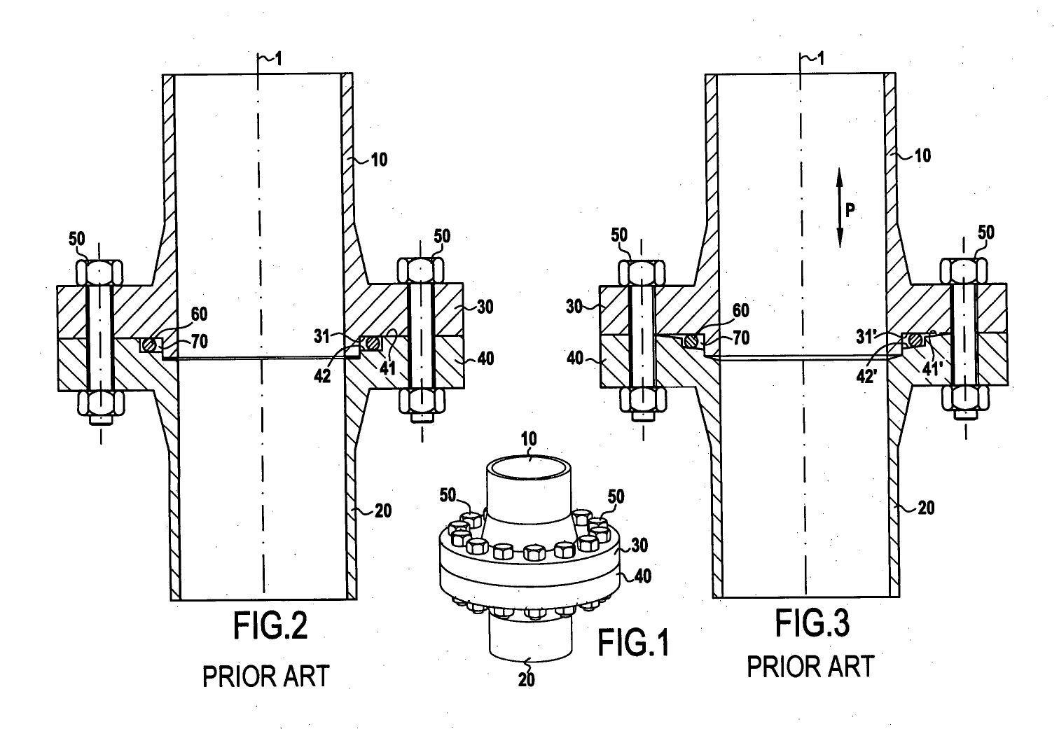

In a prior art flanged connection of the face-to-face type, such as that shown in FIGS. 2 and 3, the off-loading of the gasket can reach values greater than 0.10 mm, which makes it necessary to use special gaskets possessing usable restitution greater than 0.10 mm, or else stiffening the flanged connection, thereby making it heavier, which constitutes a handicap in various applications, particularly in space.

There follows a description with reference to FIGS. 6 and 7 of a first embodiment of a flanged prestress leaktight connection device in accordance with the invention.

In this embodiment, the pipework or tank segments 110, 120 in the form of bodies of revolution about an axis 101 are connected to respective annular flanges 130 and 140. The flanges 130 and 140 have connection elements 150 such as bolts, screws, pins, or the like, passing through them and serving to exert prestress on the flanges 130, 140.

FIG. 6 shows the connection device before the connection elements 150 are tightened.

It can be seen that the bottom face 131 of the top flange 130 which extends substantially transversely to the axis 101 is a continuous surface without any set-back portion (apart from the openings for passing the connection elements 150). The top face 141 of the bottom flange 140 is situated facing the face 131 of the flange 130 and is likewise a continuous surface extending essentially transversely to the axis 101, with the exception of openings for passing the connection elements 150, and a set-back portion 142 that is to form the housing 170 for the gasket 160.

It should be observed that the terms “bottom” and “top” are used for convenience with reference to the position of the flanges in the drawing, and that the flanged connection could naturally take up any position relative to the vertical.

In the initial position shown in FIG. 6, the surfaces 131 and 141 are in contact over a first zone Z1 in the vicinity of the gasket 160, e.g. over a distance which may be of the order of several millimeters if the diameter of the flange is less than or equal to about 200 mm, or of the order of several centimeters if the diameter of the flange is greater than about 200 mm. In contrast, in a zone Z2 situated between the connection means 150 and the periphery of the flanges 130 and 140, the surfaces 131 and 141 are spaced apart from each other by a certain distance E which may be of the order of a few tenths of a millimeter, for example lying in the range 0.2 mm to 0.5 mm.

After the connection elements 150 have been tightened (FIG. 7), the empty space between the surfaces 131 and 141 that were previously diverging in the zone Z2 is closed, and the faces of the flanges 130 and 140 situated facing each other are in contact over their entire area. Even when an internal pressure P is applied inside the pipework elements 110, 120, the surfaces 131 and 141 do not come apart in the zone Z1 or in the zone Z2.

The distance E in the zone Z2 is determined in such a manner that after the clamping means 150 have been tightened, the minimum force exerted on the bearing zone Z2 is less than the minimum force exerted on the first bearing zone Z1, but without being zero, constituting 1% to 20%, advantageously, 5% to 20%, and preferably 8% to 12% of the minimum force exerted on the first bearing zone Z1. As a result, in operation with an internal pressure field P, the phenomenon of the connection gaping (the housing for the gasket opening) is not observed, as it would be in a face-to-face type connection, and the phenomenon of the gasket being off-loaded is reduced to values of the order of 0.06 mm, for example, thus making it possible to use standard gaskets, for example gaskets in which the usable restitution lies in the range 0.08 mm to 0.10 mm.

The clamping force can be distributed as follows: knowing the minimum clamping force to be exerted on the first bearing zone Z1, as a function of the pressure and the external loading, calculations based on finite elements are used to optimize the difference in height between the two bearing zones Z1 and Z2, or else to optimize the angle between the surfaces 131 and 141 in an embodiment as shown in FIG. 6, where the flange is conical, with this being done by parameterization and by varying the parameters in such a manner as to obtain a force on the second bearing zone Z2 that lies in the range 1% to 20%.

Under such circumstances, after clamping, the facing surfaces 131, 141 of the flanges 130, 140 are in contact, and there does not exist any space where pollution can occur between the flanges, and heat is dissipated well through the flanges. Furthermore, in operation under the influence of internal pressure, the contact pressure in the zone Z1 moves towards the outer diameter in the zone Z2, but nevertheless the contact area remains large in the zone Z1, and no or minimal separation is observed, so the quality of the sealing provided by the gasket is not affected.

The profiles of the surfaces 131, 141 are defined, for example, by calculation using finite elements in such a manner that after tightening, the contact pressure remains low in the zone Z2 and is high in the zone Z1 situated closer to the gasket.

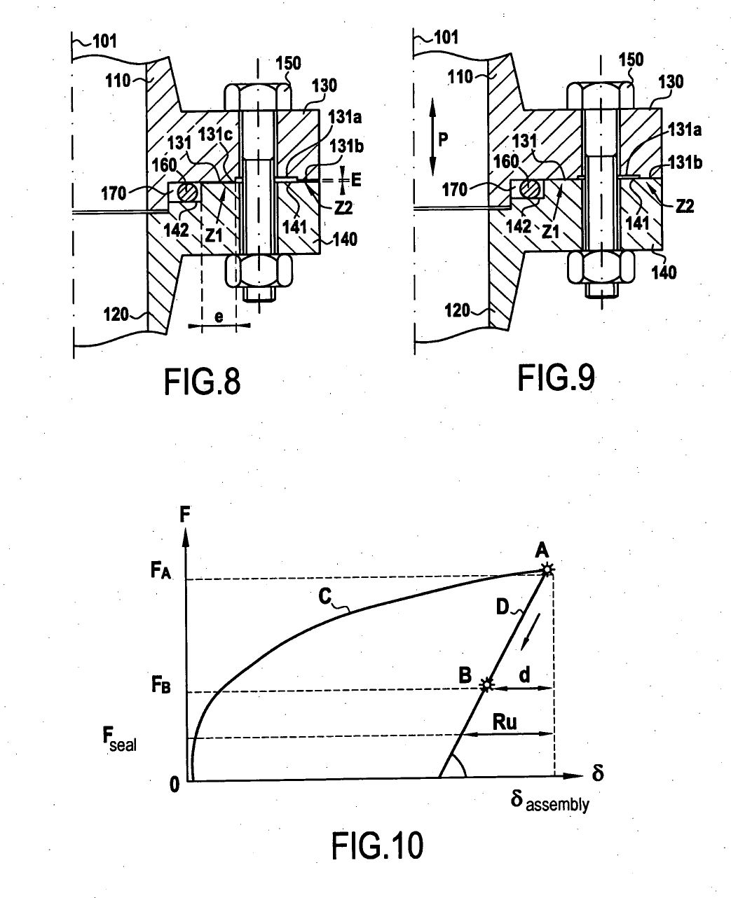

There follows a description of another embodiment of the invention given with reference to FIGS. 8 and 9.

In FIGS. 8 and 9, elements that are similar to those of the embodiment of FIGS. 6 and 7 are given the same reference numerals and they are not described again.

The flanged prestress leaktight connection device of FIGS. 8 and 9 presents a flange 140 that is identical to the flange 140 of the device of FIGS. 6 and 7. In contrast, the flange 130 of the device in FIGS. 8 and 9 has a bottom surface 131 that is not continuous but that includes a set-back portion 131a following the zone Z1 where the surface 131c of the top flange 130 (which constitutes a first land) is in contact over a length e with the surface 141 of the bottom flange 140, with the set-back portion 131a being followed by an end portion 131b that constitutes a second land.

In the assembly position, prior to tightening the connection bolts 150 (FIG. 8), the surface 131c of the flange 130 is in contact with the surface 141 of the flange 140 in the zone Z1 over the distance e, which distance is a few millimeters, for example, if the diameter of the flange is less than or equal to about 200 mm, or is equal to one or more centimeters if the diameter of the flange is greater than about 200 mm. There is also a space E of the order of a few tenths of a millimeter, e.g. 0.3 mm to 0.8 mm in the zone Z2 between the first land 131b of the flange 130 and the facing surface 141 of the flange 140.

After the clamping means 150 have been tightened (FIG. 9), the surfaces 131c and 141 remain in contact in the zone Z1, and the land 131b itself comes into contact with the surface 141 of the flange 140 so that there is no open space at the periphery of the flanges 130 and 140.

As in the embodiment of FIGS. 6 and 7, after the bolts 150 have been tightened, the minimum force exerted on the bearing zone Z2 is less than the minimum force exerted on the bearing zone Z1, but without being zero, and constituting 1% to 20%, advantageously 5% to 20%, and preferably 8% to 12% of the minimum force exerted on the bearing zone Z1.

In operation, when a pressure P is exerted inside the pipework segments 110, 120, no gaping of the connection is observed, i.e. no gaping of the kind that would be observed in a similar connection, but of the face-to-face type without a land. Furthermore, an embodiment with lands 131c and 131b in the zones Z1 and Z2 as described above presents a function of limiting turning of the flanges because of the thrust delivered in the zone Z2 by the outer land 131b.

On assembly, contact pressure is observed to be localized close to the diameter of the gasket in the bearing zone Z1. In operation, the contact pressure moves towards the outer diameter, but contact continues to be remained over both lands 131b and 131c. This enables contact pressure to be conserved closer to the gasket.

A two-land type connection device as shown in FIGS. 8 and 9 makes it possible to reduce the off-loading on the gasket relative to a traditional face-to-face connection even more than with the device of FIGS. 6 and 7, thus making it possible to use gaskets having smaller usable restitution, e.g. of the order of 0.05 mm or even presenting usable restitution that is less than that, e.g. 0.02 mm for flanges of small diameter. In general, it is possible to use gaskets presenting usable restitution that is less than 0.1 mm.

A two-land type flanged prestressed leaktight connection device presents very great stiffness and deformation that is quasi-constant between assembly and operation, while defining a space that is closed against external pollution.

The presence of two contact surfaces in two bearing zones Z1, Z2 situated on the two lands 131c, 131b enables contact pressure to be distributed as well as possible while avoiding any clearance and giving great flexibility in design and assembly since the machining required is easy and it is possible for the bolts to be over-tightened, since the second land 131b forms a safety abutment.

As can be seen from FIG. 8, the outer land 131b is smaller in height than the inner land 131c, and it is this difference in level that makes it possible to adjust the prestress and to distribute forces so that the load at the periphery of the flanges tends towards zero (zone Z2) while the load is maintained at a high level in the vicinity of the gasket (zone Z1).

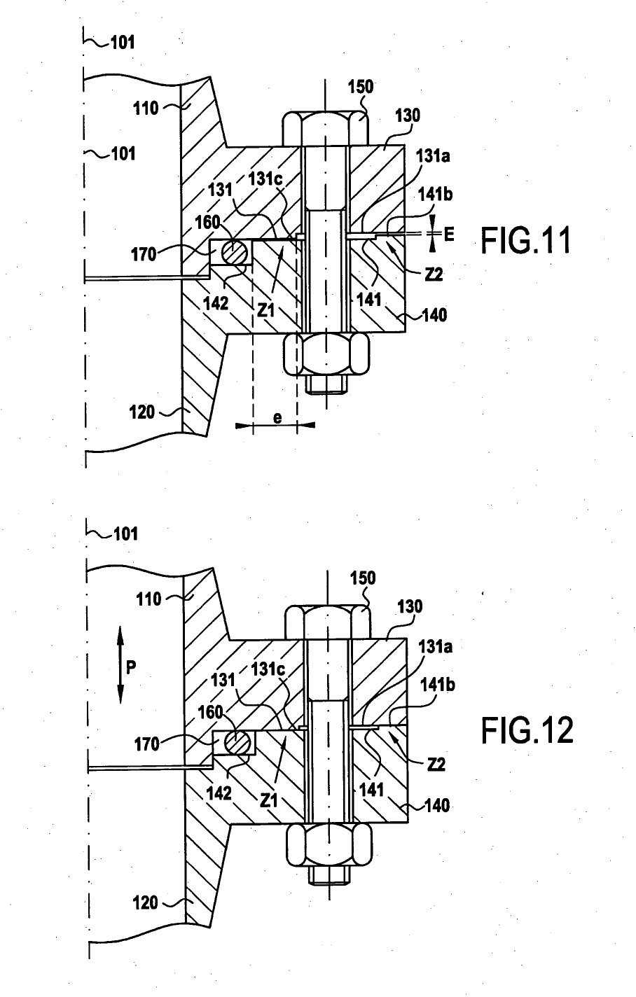

FIGS. 11 and 12 show a variant embodiment for the connection device of FIGS. 8 and 9.

In the embodiment of FIGS. 11 and 12, the facing surfaces 131 and 141 of the flanges 130 and 140 continue to define two lands, but they are not made on the same surface.

In the embodiments of FIGS. 11 and 12, the contact surface 131 of the flange 130 has a single land 131c formed in the bearing zone Z1, making it possible on assembly and prior to the bolts 150 being tightened to have contact with the surface 141 of the flange 140 over a length e (FIG. 11).

The other flange 140 has its own land 141b formed facing the surface 131a of the flange 130 in the bearing zone Z2, leaving a space E relative to this surface 131a before the bolts 150 are tightened (FIG. 11).

After the bolts 150 have been tightened, the land 141b of the surface 141 of the flange 140 comes into abutment against the surface 131a of the flange 130 in the bearing zone Z2, thereby contributing to closing the space between the flanges 130 and 140 at their periphery (FIG. 12).

When the pipework segments 110 and 120 are put under internal pressure P, the lands 131c and 141b perform exactly the same roles as the lands 131c and 131b in the embodiment of FIGS. 8 and 9.

In some circumstances, making only one land per flange can make it easier to fabricate the flanges 130, 140, but from a functional point of view the embodiment of FIGS. 11 and 12 is strictly equivalent to that of FIGS. 8 and 9.

In the embodiment shown in FIGS. 11 and 12, the length e of the bearing zone Z1 can be of the order of a few millimeters or a few centimeters, while the empty space E between the land 141b and the facing surface 131a, prior to the bolts 150 being tightened, can typically be of the order of 0.05 mm. The height of the land 141b, like that of the land 131b in FIGS. 8 and 9, can also typically be of the order of 0.05 mm, such that height of the land 131c can typically be of the order of 0.1 mm.

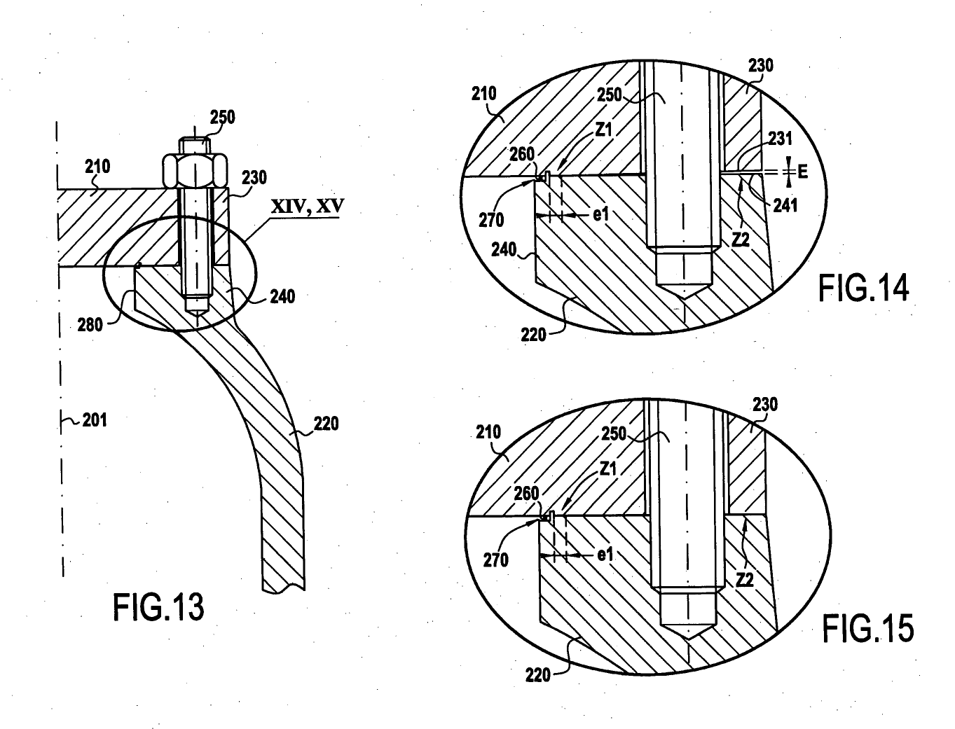

FIGS. 13 to 15 show an application of the invention to an enclosure that is to contain a fluid, such as hydrogen, under pressure, e.g. of the order of 320 bar.

In this application, a flange 230 is constituted by the peripheral portion of a stopper or lid 210. The flange 230 rests on a flange 240 constituted by the top portion of the tank 220, the flange 240 defining an internal opening or manhole 280. The flanges 230 and 240 are connected together by pins 250 distributed around the periphery of the annular flanges 230 and 240.

In the example described, the opening 280 presents a diameter of 500 mm, and a gasket 260 placed in a gasket housing 270 in the vicinity of the opening 280 presents a diameter of 520 mm.

The pins 250 are distributed on a circle having a diameter of 900 mm, there being sixteen pins. The tension on each pin is 565 kilonewtons (kN).

The O-ring gasket used presents a torus diameter of 9.4 mm and has usable restitution of 0.09 mm. The flattening force of the gasket is 580 N/mm.

The configuration visible in FIG. 14 prior to tightening the pins 250, and in FIG. 15 after tightening the pins 250, is similar to that described above with reference to FIGS. 6 and 7.

Thus, the bottom surface 231 of the portion 230 of the stopper 210 is machined in such a manner that when the stopper 210 is assembled on the tank 220, and prior to tightening the pins 250, there is no contact between the entire bottom surface 231 of the flange 230 and the top surface 241 of the flange 240, unlike a face-to-face type connection, but instead these surfaces 231 and 241 diverge and come into contact initially only over a distance e, e.g. of the order of 12 mm, in a bearing zone Z1 situated in the vicinity of the gasket 260, whereas at the periphery of the flanges 230, 240, outside the pins 250, in a zone Z2, there is an empty space E, e.g. lying in the range 0.3 mm to 0.6 mm between the surfaces 231 and 241 (FIG. 14).

After the pins 250 have been tightened, there is no longer any empty space E in the bearing zone Z2 and the connection is closed in sealed manner with prestress that increases the sealing margin and reduces the off-loading of the gasket 260.

FIG. 17 shows that for a gasket 260 presenting usable restitution Ru of 0.09 mm, the off-loading of this gasket depends on the conicity of the connection, i.e. on the value of the empty space E between the surfaces 231 and 241 in the bearing zone Z2 before the pins 250 are tightened, in the above example.

Curve G shows that values for E lying in the range 0.3 mm to 1 mm make it possible to obtain off-loading lying in the range 0.025 mm to 0.035 mm, i.e. much smaller than the usable restitution Ru of the gasket, thereby guaranteeing good sealing, without it being necessary to make use of a gasket that provides much greater usable restitution.

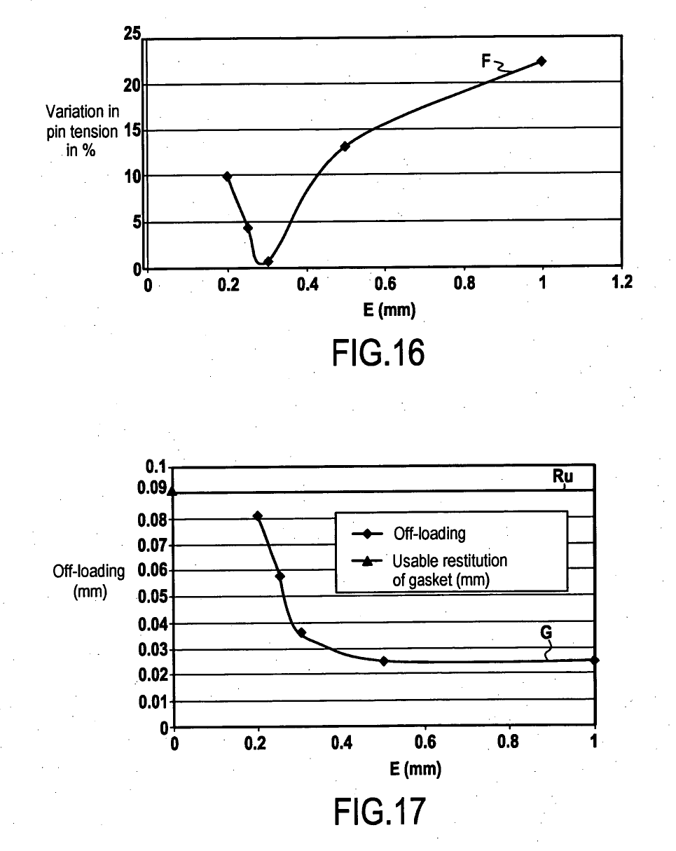

It can thus be seen that the greater the value E, the smaller the value of the off-loading. Nevertheless, if account is also taken of variation in the tension in a pin during pressurization and as a function of conicity (the value of the empty space E), as shown by curve F in FIG. 16, it can be seen that a cone having an opening (empty space E) of about 0.3 mm makes it possible, in the example described, to minimize variation in the tension in a pin to a value of about 1%, whereas this variation in tension can be as great as 15% for values of E that are of the order of 0.6 mm.

Thus, in the example described, selecting a value of 0.3 mm for E makes it possible to obtain off-loading of 0.036 mm (FIG. 17) with very small variation in the tension in a pin (about 0.7%).

Off-loading of 0.036 mm represents a margin of 150% relative to the usable restitution of the gasket which is 0.09 mm. Conversely, a conventional face-to-face type connection (corresponding to the empty space E having a value equal to zero) would give rise to an increase of 52% in the tension in a pin 250 during pressurization, and to off-loading of about 0.21 mm, which is not compatible with a gasket having usable restitution of 0.09 mm. With a conventional face-to-face type connection it would therefore be necessary to design a special gasket presenting usable restitution greater than about 0.3 mm, because of the large opening created in the vicinity of the gasket in such a conventional face-to-face type connection, whereas in a connection in accordance with the invention of the kind described above there is practically no opening in the vicinity of the gasket housing 270, with deformation of the stopper matching deformation of the bottle in the vicinity of the flanges 230, 240.

Finally, it should be observed that in flanged prestressed leaktight connection devices, the flanges are advantageously made integrally without any fittings being added other than the clamping members 150, 250, thus giving them excellent ability to withstand vibration.

What is claimed is:

1. A flanged prestressed leaktight connection device comprising a first flange presenting a first contact surface, a second flange presenting a second contact surface situated facing said first contact surface, a sealing gasket disposed in a gasket housing formed between said first and second contact surfaces, and clamping means for clamping together the first and second flanges, the clamping means being disposed between the gasket housing and the periphery of the first and second flanges so as to put into contact at least a portion of the first and second contact surfaces between the flanges,
wherein the first and second contact surfaces present at least a first bearing zone situated in the vicinity of the sealing gasket and a second bearing zone situated between the clamping means and the periphery of the first and second flanges, such that after the clamping means have been tightened, the minimum force exerted on the second bearing zone is less than the minimum force exerted on the first bearing zone, but without being zero;
wherein the first and second contact surfaces define first and second bearing zones such that after the clamping means have been tightened, the minimum force exerted on the second bearing zone constitutes 1% to 20% of the minimum force exerted on the first bearing zone; and
wherein the sealing gasket presents usable restitution that is less than 0.1 mm.

2. A device according to claim 1, wherein the first bearing zone is situated between the sealing gasket and the clamping means.

3. A device according to claim 1, wherein the first and second contact surfaces define first and second bearing zones such that, after the clamping means have been tightened, the minimum force exerted on the second bearing zone constitutes 5% to 20% of the minimum force exerted on the first bearing zone.

4. A device according to claim 1, wherein the first and second contact surfaces define first and second bearing zones such that, after the clamping means have been tightened, the minimum force exerted on the second bearing zone constitutes 8% to 12% of the minimum force exerted on the first bearing zone.

5. A device according to claim 1, wherein, prior to the clamping means being tightened, the distance between the first and second contact surfaces in the second bearing zone is greater than the distance between the first and second contact surfaces in the first bearing zone.

6. A device according to claim 1, wherein the first and second contact surfaces are continuous surfaces between the first and second bearing zones.

7. A device according to claim 1, wherein at least one of the first and second contact surfaces defines a land at least in one of the first and second bearing zones.

8. A device according to claim 7, wherein the first contact surface of the first flange has a first land formed in the first bearing zone and a second land formed in the second bearing zone, while the second contact surface of the second flange presents a continuous uniform surface.

9. A device according to claim 7, wherein the first contact surface of the first flange includes a first land formed in the first bearing zone, while the second contact surface of the second flange presents a second land formed in the second bearing zone.

10. A device according to claim 1, wherein the clamping means comprise a set of bolts disposed perpendicularly to the first and second flanges.

11. A device according to claim 1, wherein the sealing gasket presents usable restitution lying in the range 0.02 mm to 0.1 mm.

12. A device according to claim 1, applied to pipework or to an enclosure containing a fluid under pressure.
